(19) United States
(12) Patent Application Publication
(10) Pub. No.: US 2025/0261802 A1
(43) Pub. Date: Aug. 21, 2025

(54) BEVERAGE PREPARATION DEVICE

(71) Applicant: Dongguan ZEEWAY-Technology Ltd, Guangdong Province (CN)

(72) Inventors: Mengyi Zhu, Guangdong Province (CN); Liang Zhou, Guangdong Province (CN); Qiaohuang Li, Guangdong Province (CN); Riling Huang, Guangdong Province (CN); Long Chen, Guangdong Province (CN); Wenchao Deng, Guangdong Province (CN); Qihong She, Guangdong Province (CN); Fulin Lv, Guangdong Province (CN)

(73) Assignee: Dongguan ZEEWAY-Technology Ltd, Guangdong Province (CN)

(21) Appl. No.: 18/955,952

(22) Filed: Nov. 21, 2024

(30) Foreign Application Priority Data
Feb. 20, 2024 (CN) 2024203154602

(51) Int. Cl. A47J 43/07

(52) U.S. Cl. CPC A47J 43/0716

(57) ABSTRACT

The present disclosure discloses a beverage preparation device comprising: an operating table having a shaft hole running downwardly through the table surface for placing operating device so that a shaft of the operating device passes therethrough, and a drive motor of the operating device is disposed below the shaft hole; further comprising a first waterproof guide channel extending from the table surface through the operating table to the exterior of the operating table to direct liquid on the table surface away from the table surface, thereby preventing the liquid from flowing into the shaft hole. The present disclosure can effectively prevent liquid on the operating table from entering the shaft hole and damaging the drive motor.

### TECHNICAL FIELD

The present disclosure relates to the field of ready-to-make beverages and, more specifically, to a beverage preparation device.

### BACKGROUND

Existing beverage preparation device often incorporates an operating table. The table is often subject to dripping or splashing of ingredients. In order for the beverage preparation device to comply with food hygiene requirements, the table needs to be cleaned at regular intervals.

Cleaning of the table is usually carried out by rinsing with water. In the case of other operating devices disposed on the table, there is a risk that the rinsing water may flow into the drives of these operating devices, and damaging to the drives and causing electrical leakage.

### SUMMARY

It is an object of the present disclosure to provide a beverage preparation device to solve or at least partially alleviate the above problems.

The disclosure provides a beverage preparation device comprising:
an operating table having a shaft hole running downwardly through the table surface for placing operating device so that a shaft of the operating device passes therethrough, and a drive motor of the operating device is disposed below the shaft hole;
further comprising a first waterproof guide channel extending from the table surface through the operating table to the exterior of the operating table to direct liquid on the table surface away from the table surface, thereby preventing the liquid from flowing into the shaft hole.

Preferably, a barrier wall is provided on the table surface extending upwardly around the shaft hole, and the first waterproof guide channel extends downwardly from the portion of the table surface within the barrier wall to the exterior of the operating table.

Preferably, a shaft seal is provided below the table surface around the output shaft of the drive motor.

Preferably, the shaft seal comprises two shaft seals provided along the output shaft of the drive motor.

Preferably, a gap is left between the mounting surface of the drive motor and the bottom of the operating table.

Preferably, a second waterproof guide channel extending exterior of the mounting surface is formed on the mounting surface of the drive motor for directing liquid away from the mounting surface of the drive motor.

Preferably, the mounting surface is configured a downward inclination.

The present disclosure has benefits as following: by providing the first waterproof guide channel on the operating table extending from the table surface through the operating table to the exterior of the operating table, the liquid on the table surface can be guided away from the operating table, thereby preventing the liquid from entering the shaft hole on the table surface. A first protection for the drive motor is thereby formed.

### BRIEF DESCRIPTION OF FIGURES

Other features, objects and advantages of the present disclosure will become more apparent by reading the detailed description of the non-limiting embodiments with reference to the following accompanying drawings:

FIG. 1 is a schematic view of a portion of an exemplary beverage preparation device of the present disclosure.

FIG. 2 is a top view of FIG. 1.

FIG. 3 is a cross-sectional view taken along A-A in FIG. 2.

### DETAILED DESCRIPTION

The present disclosure is described in further detail below in connection with the accompanying drawings and embodiments. It is to be understood that the specific embodiments described herein are only for explaining the relevant disclosure, and are not a limitation of the scope of the disclosure. It is also to be noted that for case of description, only the portions relevant to the disclosure are shown in the accompanying drawings.

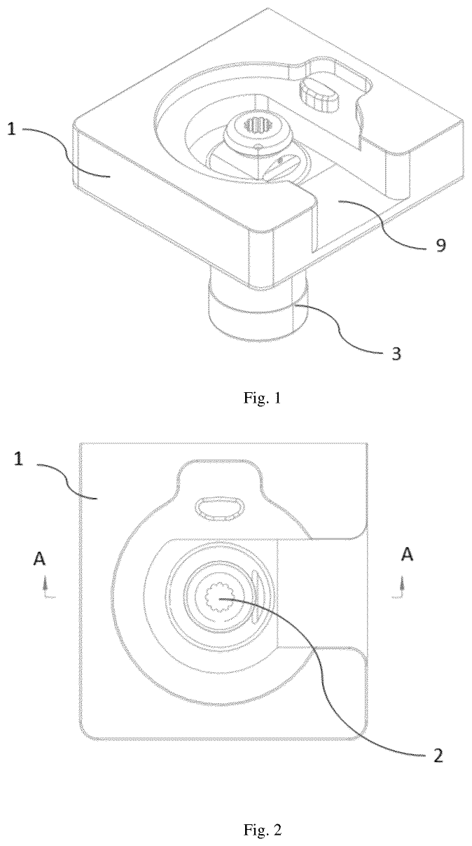

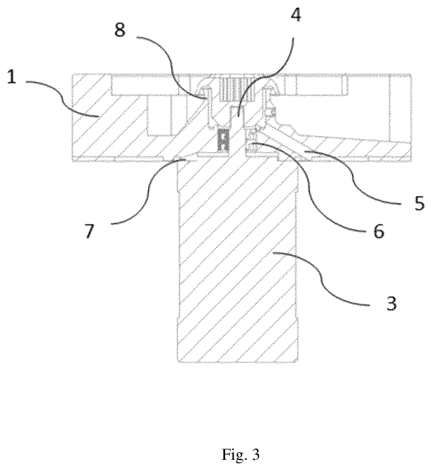

FIG. 1 is a schematic view of a portion of an exemplary beverage preparation device of the present disclosure, wherein only a portion of the operating table is shown. FIG. 2 is a top view of the operating table of FIG. 1. FIG. 3 is a cross-sectional view taken along A-A in FIG. 2. Wherein, reference number 1 is used to indicate an operating table; reference number 2 is used to indicate a shaft bore; reference number 3 is used to indicate a drive motor; reference number 4 is used to indicate an output shaft of the drive motor; reference number 5 is used to indicate a first watertight guide channel; reference number 6 is used to indicate a shaft seal; reference number 7 is used to indicate a second watertight guide channel; reference number 8 is used to indicate a barrier wall; and reference number 9 is used to indicate an outlet of the operating table.

The present disclosure is further described below with reference to the accompanying drawings.

As shown in FIGS. 1 to 3, an operating table portion of the beverage preparation device is illustrated. The operating table 1 is provided with a shaft hole 2 running downwardly from the table surface. The drive motor 3 is disposed below the shaft hole 2. For example, In the case that an in-line stirring cup (not shown) may be placed on the operating table 1, the cup opening of the stirring cup is provided corresponding to the discharge opening of the beverage preparation device. The rotary shaft of the stirrer in the stirring cup may extend into the shaft hole 2 to be operatively connected to the output shaft 4 if the drive motor that extends into the shaft hole 2 from below. When the drive motor 3 is turned, the output shaft 4 of the drive motor can rotate the rotary shaft of the stirrer to stir the ingredient liquid in the stirring cup.

Ingredient liquid may splash or leak onto the operating table during dispensing from the beverage preparation device and while the stirring cup is stirring and mixing the ingredient liquid. Droplets may also fall from the dispense port onto the operating table when the stirring cup is not in place. These ingredient liquid dropped onto the operating table may deteriorate over time and contaminate the operating table. Therefore, the operating table must be flushed.

Most of the flushing liquid will flow out of the outlet 9 on the operating table. In order to prevent the flushing liquid from entering the shaft hole 2, a barrier wall 8 is provided on the table surface of the operating table extending upwardly around the shaft hole 2, and a first waterproof guide channel 5 (as seen in FIG. 3) extending downwardly to the exterior of the operating table 1 is provided on the table surface within the barrier wall 8. By such an configuration, liquid can be effectively prevented from entering the shaft hole 2.

Referring in particular to FIG. 3, a shaft seal 6 may be provided below the table surface of the operating table 1 around the output shaft 4 of the drive motor. The illustrated shaft seals 6 have two seals, and other numbers of shaft seals may be used depending on the circumstances. The shaft seals 6, as sealing means, can play a role in intercepting the liquid leaking from the shaft holes and preventing the liquid from leaking downward.

Moreover, a gap may be left between the mounting surface of the drive motor 3 and the bottom of the operating table 1 to allow the mounting surface of the drive motor 3 to be away from the operating table 1. In the event that the liquid on the operating table leaks down from the shaft seal 6, the gap between the mounting surface of the drive motor and the bottom of the operating table may provide a space to dispose of that leaking liquid. The mounting surface of the drive motor may be inclined slightly downwardly to facilitate directing the liquid away from the output shaft 4 of the drive motor.

In this embodiment, a second waterproof guide channel 7 may be formed on the mounting surface of the drive motor, which extends to the exterior of the mounting surface for directing the liquid leaking onto the mounting surface of the drive motor away from the mounting surface of the drive motor, thereby preventing the liquid from entering the drive motor 3.

By means of the barrier wall 8 and the first waterproof guide channel 5 on the table surface of the operating table, the shaft seal 6 on the output shaft of the drive motor, and the second waterproof guide channel 7 on the mounting surface of the drive motor, a triple waterproof barrier is formed from the top to the bottom, which effectively prevents the liquid from entering the drive motor 3, thereby ensuring the safety of the use of the device and prolonging the service life of the device.

In summary, the present disclosure provides a beverage preparation device comprising an operating table 1. The operating table 1 has a downwardly penetrating shaft hole 2 on the surface of the operating table 1. The shaft hole 2 is used to place an operating device so that the shaft of the operating device passes through it, and a drive motor of the operating device is located below the shaft hole. The output shaft 4 of the drive motor may extend into the shaft hole 2 from below. When the operating device is placed in position, the output shaft 4 of the drive motor is operatively connected to the shaft of the operating device to drive the operating device to perform a particular operation.

For example, beverage preparation device typically stirs and mixes a plurality of liquid or solid ingredients to formulate beverage. Inevitably, dripping, splashing, leaking, and the like of the ingredients will occur during the making process, and these ingredient liquid will contaminate the operating table. In order to clean the operating table, the operator usually rinses it with water. However, the flushed liquid may enter the shaft hole on the operating table, and then enter the drive motor along the output shaft of the drive motor, thereby causing the drive motor to short-circuit and cause damage.

To solve this problem, the beverage preparation device of the present disclosure is provided with a first waterproof guide channel 5, which extends from the table surface of the operating table 1 through the operating table to the exterior of the operating table, to guide the liquid on the table surface away from the table surface, thereby preventing the liquid from flowing into the shaft holes and damaging the drive motor.

In the preferred embodiment, the barrier wall 8 is provided on the table surface of the operating table extending upwardly around the shaft hole 2, and the first waterproof guide channel 5 extends downwardly from the table surface within the barrier wall 8 to the exterior of the operating table. The barrier wall 8 can provide a certain degree of water blockage, but since the operating device is placed on the shaft hole 2, the barrier wall 8 cannot be too high. When flushing the operating table with water, it is still possible for liquid to pass over the barrier wall 8 and enter into the boundary of the barrier wall 8. The opening of the first waterproof guide channel 5 is provided on the table surface within the barrier wall 8 and extend downwardly to the exterior of the operating table, so that the liquid that enters within the barrier wall 8 may be directed away from the operating table, thereby preventing the liquid from entering the shaft hole 2.

In the preferred embodiment, the shaft seal 6 may be provided below the table surface of the operating table I around the output shaft 4 of the drive motor. if there is liquid flowing down from the shaft hole 2, the shaft seal 6 may play an intercepting role for the liquid, preventing the liquid from leaking downward.

In the preferred embodiment, the shaft seal 6 provided around the output shaft 4 of the drive motor may include two shaft seals 6 stacked along the output shaft 4 of the drive motor, so as to further prevent the leaking liquid from entering the drive motor 3. Of course, in order to achieve a better anti-leakage effect, more than two shaft seals may be provided.

In the preferred embodiment, a gap can be left between the mounting surface of the drive motor 3 and the bottom of the operating table to allow the drive motor to be away from the operating table. In the event of leakage of liquid from the operating table along the shaft bore 2 or failure of the shaft seal 6, the gap between the mounting surface of the drive motor 3 and the bottom of the operating table 1 may provide space to dispose of such leaked liquid. The mounting surface of the drive motor 3 may be sloped slightly downwardly to facilitate directing the liquid away downwardly.

In the preferred embodiment, the mounting surface of the drive motor 3 may be formed with the second waterproof guide channel 7 extending to exterior of the mounting surface for directing liquid leaking from the shaft bore away from the mounting surface of the drive motor, thereby preventing the liquid from entering the drive motor.

The general design idea of the present disclosure is as follows:

1. By providing a first waterproof guide channel on the operating table that extends

from the table surface through the operating table to the exterior of the operating table, the liquid on the table surface can be guided away from the operating table, thereby preventing the liquid from entering the shaft holes on the table surface. A first protection for the drive motor is thereby formed.

2, Further a barrier wall is provided around the shaft hole on the table surface to block liquid that may be present on the table surface, and a start opening of the first waterproof guide channel is provided on the table surface within the boundary of the baffle wall and extending downwardly through the operating table to guide liquid that may enter inside the barrier wall away from the operating table, thereby providing reinforced protection for the drive motor.

3. By providing a shaft seal at the output shaft of the drive motor, liquid that may leak from the shaft bore is prevented from entering the drive motor. And preferably, two shaft seals are stacked along the axial direction of the output shaft. A second protection for the drive motor is thereby formed.

4. By leaving a gap between the mounting table of the drive motor and the bottom of the operating table, and further providing a second waterproof guide channel on the mounting table, liquid that may leak from the shaft hole is guided away from the mounting table of the drive motor. A tertiary protection for the drive motor is thereby formed.

With the triple protection provided by the present disclosure, the drive motor can be effectively prevented from being damaged by liquid on the operating table entering the drive motor through the shaft hole.

The present disclosure may also include a fourth protection, for example, the structure of the shaft hole 2 may also be provided as a mushroom head structure, and the unfolded mushroom head covers the top of the barrier wall 8, which can further prevent liquid from flowing into the shaft hole from above and from the barrier wall.

The above description is only a preferred embodiment of the present disclosure and an illustration of the technical principles utilized. It should be understood by those skilled in the art that the scope of the present disclosure is not limited to the technical solution formed by a specific combination of the above technical features, but also covers other technical solutions formed by any combination of the above technical features or their equivalent features, without departing from the concept of the present disclosure mentioned above. For example, a technical solution formed by interchanging the above features with (but not limited to) technical features having similar functions disclosed in the present disclosure.

What is claimed is:

1. A beverage preparation device, comprising:
an operating table having a shaft hole running downwardly through the table surface for placing operating device so that a shaft of the operating device passes therethrough, and a drive motor of the operating device is disposed below the shaft hole; and
a first waterproof guide channel extending from the table surface through the operating table to the exterior of the operating table to direct liquid on the table surface away from the table surface, thereby preventing the liquid from flowing into the shaft hole.

2. The beverage preparation device of claim 1, wherein a barrier wall is provided on the table surface extending upwardly around the shaft hole, and the first waterproof guide channel extends downwardly from the portion of the table surface within the barrier wall to the exterior of the operating table.

3. The beverage preparation device of claim 1, wherein a shaft seal is provided below the table surface around the output shaft of the drive motor.

4. The beverage preparation device of claim 3, wherein the shaft seal comprises two shaft seals provided along the output shaft of the drive motor.

5. The beverage preparation device of claim 1, wherein a gap is left between the mounting surface of the drive motor and the bottom of the operating table.

6. The beverage preparation device of claim 5, wherein a second waterproof guide channel extending exterior of the mounting surface is formed on the mounting surface of the drive motor for directing liquid away from the mounting surface of the drive motor.

7. The beverage preparation device of claim 5, wherein the mounting surface is configured a downward inclination.
